(19) United States
(12) Patent Application Publication
(10) Pub. No.: US 2007/0270208 A1
(43) Pub. Date: Nov. 22, 2007

(54) Wagering game with improved payline and payline-wager amount indicators

(76) Inventors: Chris J. Caspers, Erskineville (AU); James S. Halprin, Chicago, IL (US); Larry J. Pacey, Northbrook, IL (US); Trung Hoang, Canley Vale (AU)

Correspondence Address: NIXON PEABODY LLP, 161 N CLARK ST., 48TH FLOOR, CHICAGO, IL, 60601-3213, US

(21) Appl. No.: 11/799,534

(22) Filed: May 2, 2007

Related U.S. Application Data
(60) Provisional application No. 60/796,710, filed on May 2, 2006.

(51) Int. Cl. A63F 13/00

(52) U.S. Cl. 463/20

(57) ABSTRACT

According to one aspect of the present invention, a gaming machine for conducting a wagering game includes a display for displaying a plurality of symbols on a plurality of reels defining an array. The array includes a plurality of player-selectable paylines indicating symbol combinations in the array. The gaming machine also includes a player-input device, a payline indicator, and a controller. The player-input device receives input from a player for selecting one or more of the player-selectable paylines. The payline indicator is movable along a vertical path in a direction alongside the plurality of reels and indicates a number corresponding to the selected ones of the player-selectable paylines. The controller is in communication with the display and is programmed to activate the selected ones of the player-selectable paylines during the wagering game.

### CROSS REFERENCE TO RELATED APPLICATIONS

This application claims priority to U.S. Provisional Patent Application No. 60/796,710, filed May 2, 2006, which is hereby incorporated by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and methods for playing wagering games, and more particularly, to a gaming machine having a movable payline indicator.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

Typically, players select one or more paylines when placing a wager during a wagering game. In general, a payline is a line across an array of symbols, where the array is formed by mechanical or video reels. The number of paylines chosen is typically displayed on a payline indicator. One problem associated with current payline indicators is that they are immobile devices. Providing moving payline indicators may increase visual, entertainment, and excitement value associated with the wagering game.

Thus, there is a need to provide a movable payline indicator for a wagering game. The present invention fulfills this and other needs.

### SUMMARY OF THE INVENTION

According to one aspect of the present invention, a gaming machine for conducting a wagering game includes a display for displaying a plurality of symbols on a plurality of reels defining an array. The array includes a plurality of player-selectable paylines indicating symbol combinations in the array. The gaming machine also includes a player-input device, a payline indicator, and a controller. The player-input device receives input from a player for selecting one or more of the player-selectable paylines. The payline indicator is movable along a vertical path in a direction alongside the plurality of reels and indicates a number corresponding to the selected ones of the player-selectable paylines. The controller in communication with the display is programmed to activate the selected ones of the player-selectable paylines during the wagering game.

According to another aspect of the invention, a method of conducting a wagering game on a gaming machine comprises the act of displaying a plurality of symbols arranged in an array. The array includes a plurality of player-selectable paylines indicating symbol combinations in the array. The method further comprises the act of selecting, via a player-input device, one or more of the player-selectable paylines. The player-selectable paylines range between a minimum number of paylines and a maximum number of paylines. In response to the selecting, the method further includes the act of moving a payline indicator along a vertical path alongside said array for indicating a number that corresponds to the selected ones of the player-selectable paylines. The method also includes activating the selected ones of the player-selectable paylines during the wagering game.

According to yet another aspect of the invention, a gaming machine for conducting a wagering game includes a display for displaying a plurality of symbols arranged in an array. The array includes a plurality of player-selectable paylines extending across symbol locations in the array. The gaming machine further includes a payline input device, wager input device, a payline-wager indicator, and a controller. The payline input device receives input from a player for selecting one or more of the player-selectable paylines. The wager input device receives input from a player for a wager for each of said selected player-selectable paylines. The payline-wager indicator is movable along a vertical path for indicating wagers corresponding to selected ones of the player-selectable paylines. The controller is in communication with the display and is programmed to activate the selected ones of the player-selectable paylines.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1a is a perspective view of a free standing gaming machine embodying the present invention.

FIG. 1b is a perspective view of a handheld gaming machine embodying the present invention.

FIG. 2 is a block diagram of a control system suitable for operating the gaming machines of FIGS. 1a and 1b.

FIG. 3 is a representation of a game screen having one active payline according to one embodiment of the present invention.

FIG. 4 is a representation of a game screen having five active paylines according to another embodiment of the present invention.

FIG. 5 is a representation of a game screen having thirty active paylines according to an alternative embodiment of the present invention.

FIG. 6 is a representation of a payline representative of an alternative embodiment of the payline input and indicator devices illustrated in FIGS. 3-5.

FIG. 7 illustrates yet another alternative embodiment of the payline input and indicator devices illustrated in FIGS. 3-5.

FIG. 8 represents a variation of the payline input and indicator devices shown in FIG. 7.

FIG. 9 illustrates another embodiment of a movable wager per payline indicator.

FIG. 10 illustrates a game screen providing a slide-out window under certain conditions.

FIG. 11 represents a game screen with a winning payline after the reels have been spun.

FIG. 12 illustrates an alternative embodiment of the winning payline of FIG. 11.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

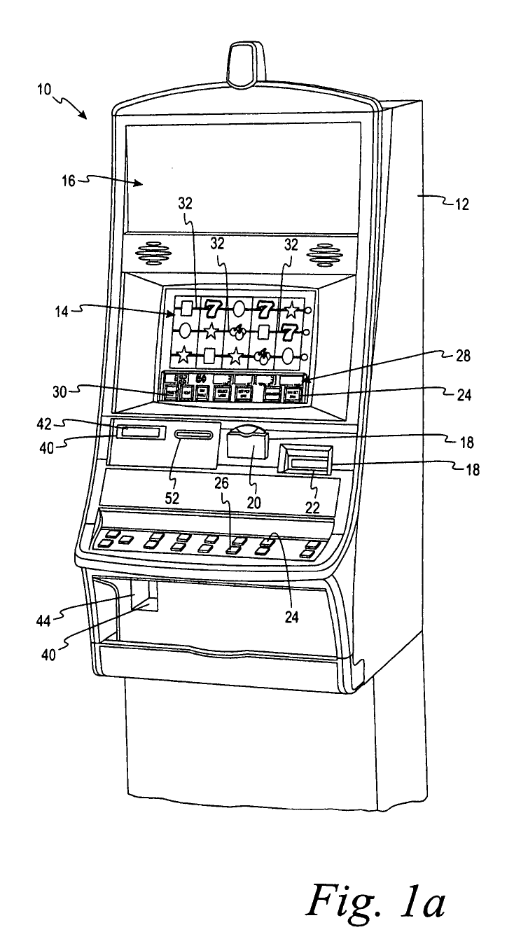

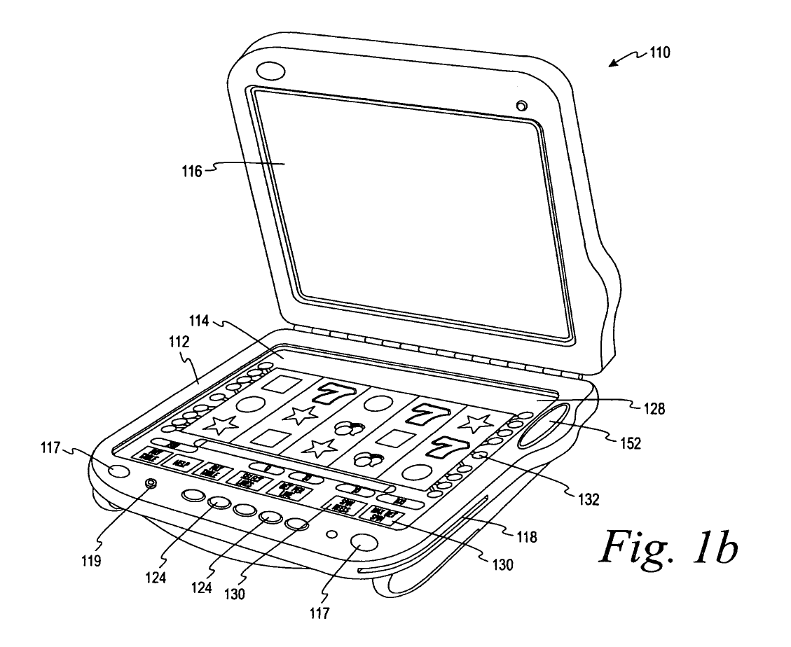

Referring to FIG. 1a, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as blackjack, slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1a). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1a, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire monitor (or a portion thereof) to allow players to make game-related selections. Alternatively, the primary display 14 of the gaming machine 10 may include a number of mechanical reels to display the outcome in visual associated to at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1a as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

Depicted in FIG. 1b is a handheld or mobile gaming machine 110. Like the free standing gaming machine 10, the handheld gaming machine 110 is preferably an electronic gaming machine configured to play a video casino game such as, but not limited to, blackjack, slots, keno, poker, blackjack, and roulette. The handheld gaming machine 110 comprises a housing or casing 112 and includes input devices, including a value input device 118 and a player input device 124. For output the handheld gaming machine 110 includes, but is not limited to, a primary display 114, a secondary display 116, one or more speakers 117, one or more player-accessible ports 119 (e.g., an audio output jack for headphones, a video headset jack, etc.), and other conventional I/O devices and ports, which may or may not be player-accessible. In the embodiment depicted in FIG. 1b, the handheld gaming machine 110 comprises a secondary display 116 that is rotatable relative to the primary display 114. The optional secondary display 116 may be fixed, movable, and/or detachable/attachable relative to the primary display 114. Either the primary display 114 and/or secondary display 116 may be configured to display any aspect of a non-wagering game, wagering game, secondary games, bonus games, progressive wagering games, group games, shared-experience games or events, game events, game outcomes, scrolling information, text messaging, emails, alerts or announcements, broadcast information, subscription information, and handheld gaming machine status.

The player-accessible value input device 118 may comprise, for example, a slot located on the front, side, or top of the casing 112 configured to receive credit from a stored-value card (e.g., casino card, smart card, debit card, credit card, etc.) inserted by a player. In another aspect, the player-accessible value input device 118 may comprise a sensor (e.g., an RF sensor) configured to sense a signal (e.g., an RF signal) output by a transmitter (e.g., an RF transmitter) carried by a player. The player-accessible value input device 118 may also or alternatively include a ticket reader, or barcode scanner, for reading information stored on a credit ticket, a card, or other tangible portable credit or funds storage device. The credit ticket or card may also authorize access to a central account, which can transfer money to the handheld gaming machine 110.

Still other player-accessible value input devices 118 may require the use of touch keys 130 on the touch-screen display (e.g., primary display 114 and/or secondary display 116) or player input devices 124. Upon entry of player identification information and, preferably, secondary authorization information (e.g., a password, PIN number, stored value card number, predefined key sequences, etc.), the player may be permitted to access a player's account. As one potential optional security feature, the handheld gaming machine 110 may be configured to permit a player to only access an account the player has specifically set up for the handheld gaming machine 110. Other conventional security features may also be utilized to, for example, prevent unauthorized access to a player's account, to minimize an impact of any unauthorized access to a player's account, or to prevent unauthorized access to any personal information or funds temporarily stored on the handheld gaming machine 110.

The player-accessible value input device 118 may itself comprise or utilize a biometric player information reader which permits the player to access available funds on a player's account, either alone or in combination with another of the aforementioned player-accessible value input devices 118. In an embodiment wherein the player-accessible value input device 118 comprises a biometric player information reader, transactions such as an input of value to the handheld device, a transfer of value from one player account or source to an account associated with the handheld gaming machine 110, or the execution of another transaction, for example, could all be authorized by a biometric reading, which could comprise a plurality of biometric readings, from the biometric device.

Alternatively, to enhance security, a transaction may be optionally enabled only by a two-step process in which a secondary source confirms the identity indicated by a primary source. For example, a player-accessible value input device 118 comprising a biometric player information reader may require a confirmatory entry from another biometric player information reader 152, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 118 may be provided remotely from the handheld gaming machine 110.

The player input device 124 comprises a plurality of push buttons 126 on a button panel for operating the handheld gaming machine 110. In addition, or alternatively, the player input device 124 may comprise a touch screen mounted to a primary display 114 and/or secondary display 116. In one aspect, the touch screen is matched to a display screen having one or more selectable touch keys 130 selectable by a user's touching of the associated area of the screen using a finger or a tool, such as a stylus pointer. A player enables a desired function either by touching the touch screen at an appropriate touch key 130 or by pressing an appropriate push button 126 on the button panel. The touch keys 130 may be used to implement the same functions as push buttons 126. Alternatively, the push buttons 126 may provide inputs for one aspect of the operating the game, while the touch keys 130 may allow for input needed for another aspect of the game. The various components of the handheld gaming machine 110 may be connected directly to, or contained within, the casing 112, as seen in FIG. 1b, or may be located outboard of the casing 112 and connected to the casing 112 via a variety of hardwired (tethered) or wireless connection methods. Thus, the handheld gaming machine 110 may comprise a single unit or a plurality of interconnected parts (e.g., wireless connections) which may be arranged to suit a player's preferences.

The operation of the basic wagering game on the handheld gaming machine 110 is displayed to the player on the primary display 114. The primary display 114 can also display the bonus game associated with the basic wagering game. The primary display 114 preferably takes the form of a high resolution LCD, a plasma display, an LED, or any other type of display suitable for use in the handheld gaming machine 110. The size of the primary display 114 may vary from, for example, about a 2-3″ display to a 15″ or 17″ display. In at least some aspects, the primary display 114 is a 7″-10″ display. As the weight of and/or power requirements of such displays decreases with improvements in technology, it is envisaged that the size of the primary display may be increased. Optionally, coatings or removable films or sheets may be applied to the display to provide desired characteristics (e.g., anti-scratch, anti-glare, bacterially-resistant and anti-microbial films, etc.). In at least some embodiments, the primary display 114 and/or secondary display 116 may have a 16:9 aspect ratio or other aspect ratio (e.g., 4:3). The primary display 114 and/or secondary display 116 may also each have different resolutions, different color schemes, and different aspect ratios.

As with the free standing gaming machine 10, a player begins play of the basic wagering game on the handheld gaming machine 110 by making a wager (e.g., via the value input device 18 or an assignment of credits stored on the handheld gaming machine via the touch screen keys 130, player input device 124, or buttons 126) on the handheld gaming machine 10. In at least some aspects, the basic game may comprise a plurality of symbols arranged in an array, and includes at least one payline 132 that indicates one or more outcomes of the basic game. Such outcomes are randomly selected in response to the wagering input by the player. At least one of the plurality of randomly selected outcomes may be a start-bonus outcome, which can include any variations of symbols or symbol combinations triggering a bonus game.

In some embodiments, the player-accessible value input device 118 of the handheld gaming machine 110 may double as a player information reader 152 that allows for identification of a player by reading a card with information indicating the player's identity (e.g., reading a player's credit card, player ID card, smart card, etc.). The player information reader 152 may alternatively or also comprise a bar code scanner, RFID transceiver, or computer readable storage medium interface. In one presently preferred aspect, the player information reader 152, shown by way of example in FIG. 1, comprises a biometric sensing device.

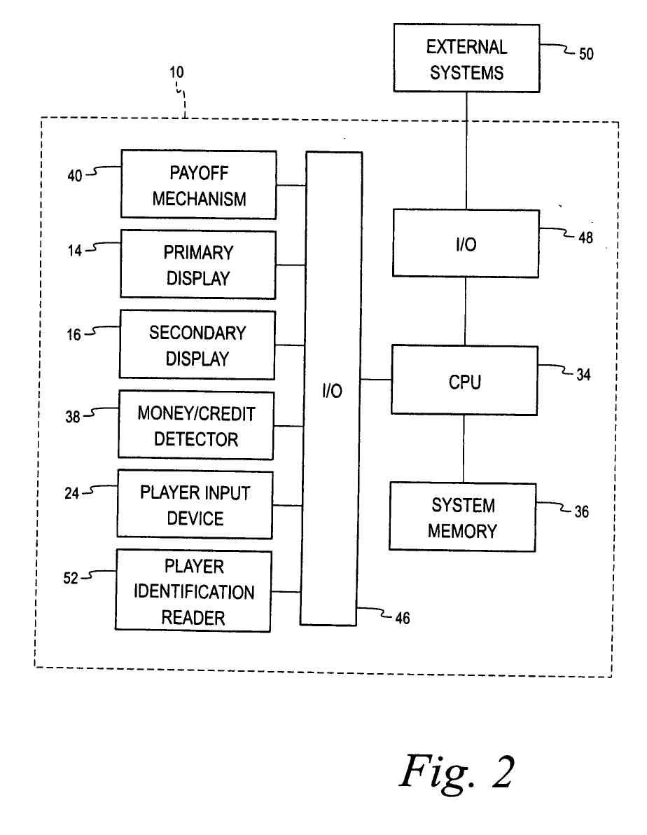

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36.

The gaming machines 10,110 may communicate with external systems 50 (in a wired or wireless manner) such that each machine operates as a “thin client,” having relatively less functionality, a “thick client,” having relatively more functionality, or through any range of functionality therebetween. As a generally “thin client,” the gaming machine may operate primarily as a display device to display the results of gaming outcomes processed externally, for example, on a server as part of the external systems 50. In this “thin client” configuration, the server executes game code and determines game outcomes (e.g., with a random number generator), while the controller 34 on board the gaming machine processes display information to be displayed on the display(s) of the machine. In an alternative “thicker client” configuration, the server determines game outcomes, while the controller 34 on board the gaming machine executes game code and processes display information to be displayed on the display(s) of the machines. In yet another alternative “thick client” configuration, the controller 34 on board the gaming machine 110 executes game code, determines game outcomes, and processes display information to be displayed on the display(s) of the machine. Numerous alternative configurations are possible such that the aforementioned and other functions may be performed onboard or external to the gaming machine as may be necessary for particular applications. It should be understood that the gaming machines 10,110 may take on a wide variety of forms such as a free standing machine, a portable or handheld device primarily used for gaming, a mobile telecommunications device such as a mobile telephone or personal digital assistant (PDA), a counter top or bar top gaming machine, or other personal electronic device such as a portable television, MP3 player, entertainment device, etc.

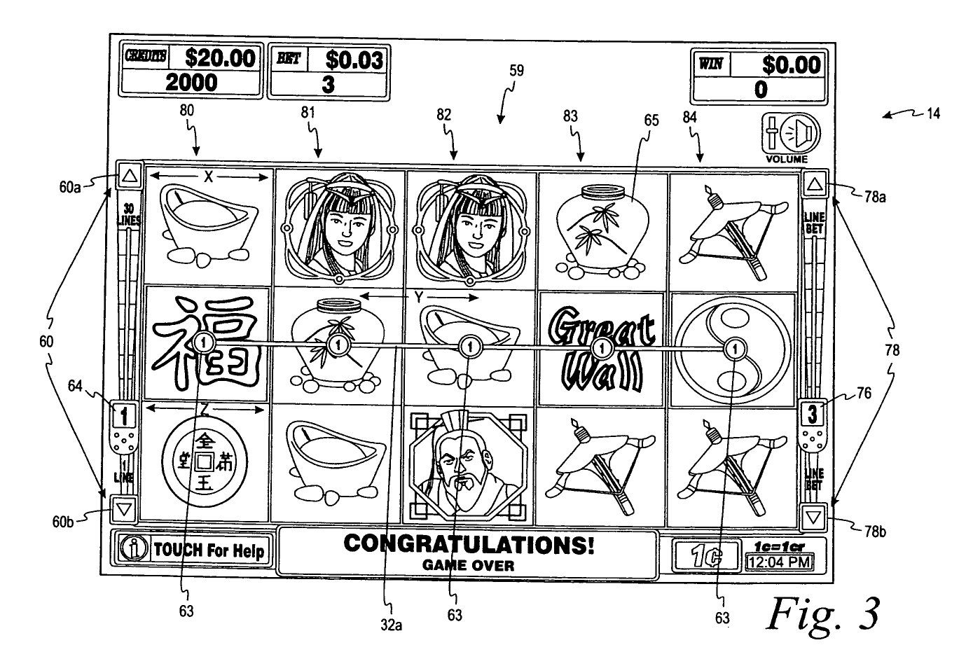

Turning now to FIG. 3, the primary display 14 shows a game screen 59 including five reels 80-84 with symbols (e.g., a flower pot symbol 65) thereon being displayed in an array. In this embodiment, three symbol locations on each reel 80-84 are visible when the reels 80-84 are not spinning. The vertical locations of the symbols on each reel 80-84 are defined by identifiers X, Y, and Z. The top row will be denoted by X, the middle row will be denoted by Y, and the bottom row will be denoted by Z.

A payline player-input device 60 is provided for receiving input from a player for selecting one or more paylines 32. Typically, the number of player-selectable paylines 32 range from a minimum number to a maximum number. In the illustrated embodiment, the player-selectable paylines range from one payline to thirty paylines.

A movable payline indicator 64 displays to the player the currently selected number of paylines before a spin is generated. For example, as illustrated in FIG. 3, the payline indicator 64 indicates that one (“1”) player-selectable payline 32 has been selected. The selected payline is represented by a continuous line extending across the pre-determined symbol locations included in the first payline 32a. However, the selected payline may also be represented in a number of other ways. For example, the selected payline may highlight the symbol positions which comprise the symbol combination designated by the payline. In this way, a selected payline indicated a certain combination of symbol positions which are evaluated for winning symbol combinations. The first payline 32a corresponds to the number shown on the payline indicator 64 (i.e., “1”) and may include tags 63 for identifying the specific symbol locations. The tags 63 also display a number that corresponds to the number that is displayed on the payline indicator 64 (i.e., “1”).

The payline player-input device 60 includes a payline increaser 60a and a payline decreaser 60b. The payline increaser 60a may be used to increase the number of player-selectable paylines 32 selected within a given wagering game. For example, if a player wishes to select additional paylines, he or she would use the payline increaser 60a to increase the number of paylines 32. Likewise, the payline decreaser 60b may be used to decrease the number of player-selectable paylines. Alternatively, the payline increaser 60a and decreaser 60b can be a simple upward or downward movement along a touch screen over the images of the payline player-input device 60. The payline player-input devise 60, the payline increaser 60a and/or the and/or the payline decreaser 60b can be electromechanical buttons, dials, sliders, or soft key touch screen buttons or touch screen gestures (e.g., sliding), etc.

For a single increment and/or a single reduction in the number of paylines, the player briefly contacts the payline increaser 60a and/or payline decreaser 60b. For example, to increase the number of paylines from one to two, a player briefly contacts the payline increaser 60a. At this point, a “2” is displayed on the payline indicator 64 (not illustrated) and accordingly, a second payline (not illustrated) with corresponding tags is displayed on the specific symbol locations included in the second payline to illustrate the second payline to the player. To increase the number of paylines further, the player continues contact with the payline increaser 60a. As the number of paylines is increased, which is indicated by the payline indicator 64, each payline corresponding to the number shown on the payline indicator 64 is displayed on the symbol locations. For example, if the player selects ten paylines 32, the payline indicator 64 will successively show numbers “1” through “10” as the number of selected paylines 32 is increased from one payline 32 to ten paylines 32.

Other embodiments may include the non-successive incrementation of paylines. For example, the payline increaser 60a may increase the number of paylines by increments of five each time it is activated. The payline increaser 60a may also increase the number of paylines by non-consistent pre-determined increments. For example, activating the payline increaser 60a once will increase the number of paylines from one to three. Activating the payline increaser a second time may increase the number of paylines from three to nine.

It should also be noted that the player may maintain continuous contact with the payline increaser 60a for longer periods of time to enable a more rapid increment in the number of paylines. While the above-described examples have been provided in relation to the increase in number of paylines, it should be noted that the same actions described above may also be applied to the payline decreaser 60b. The game screen 59 may also include a movable wager per payline indicator 76 and a wager per payline player-input device 78 which will be described in more detail below.

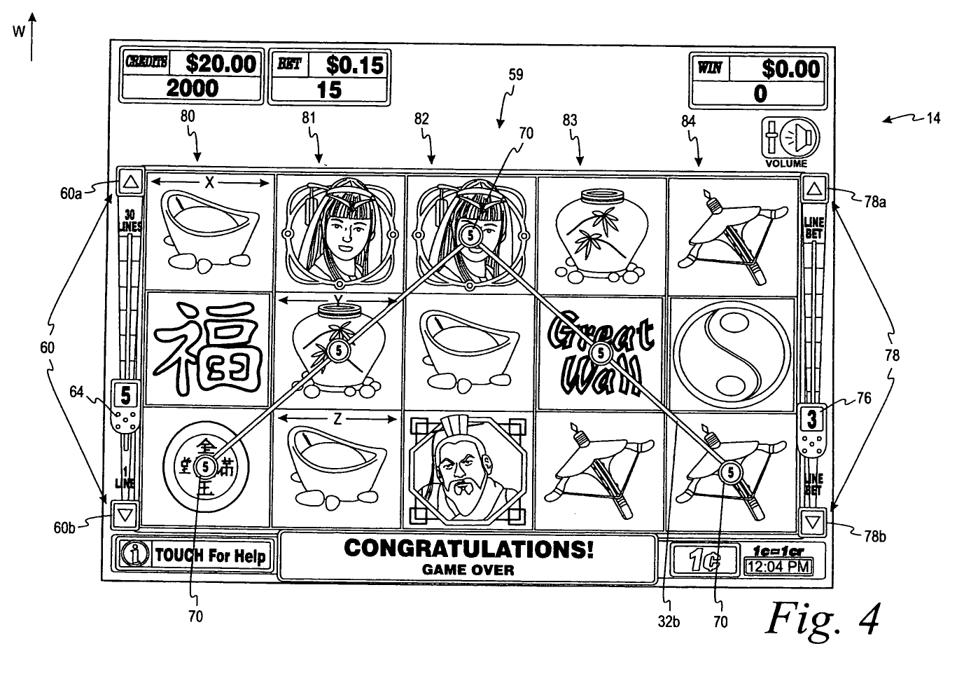

Referring now to FIG. 4, the player has used the payline increaser 60a to increase the number of paylines from one to five, as displayed on the payline indicator 64. Accordingly, in this embodiment, five paylines are selected before the spin is generated. The game screen 59 shows a fifth payline 32b corresponding to the number displayed on the payline indicator 64. The fifth payline 32b is displayed and located along the symbol locations 80z, 81y, 82x, 83y, and 84z. Tags 70 are provided on each symbol location in the fifth payline 32b to indicate the payline number (i.e., “5”). In addition to the number displayed on the payline indicator 64, the payline indicator 64 has moved a certain distance in the direction of arrow W to visually show the increase from one payline to five paylines. While only the fifth payline 32b is shown, the first to forth paylines can be simultaneously displayed with their respective tags.

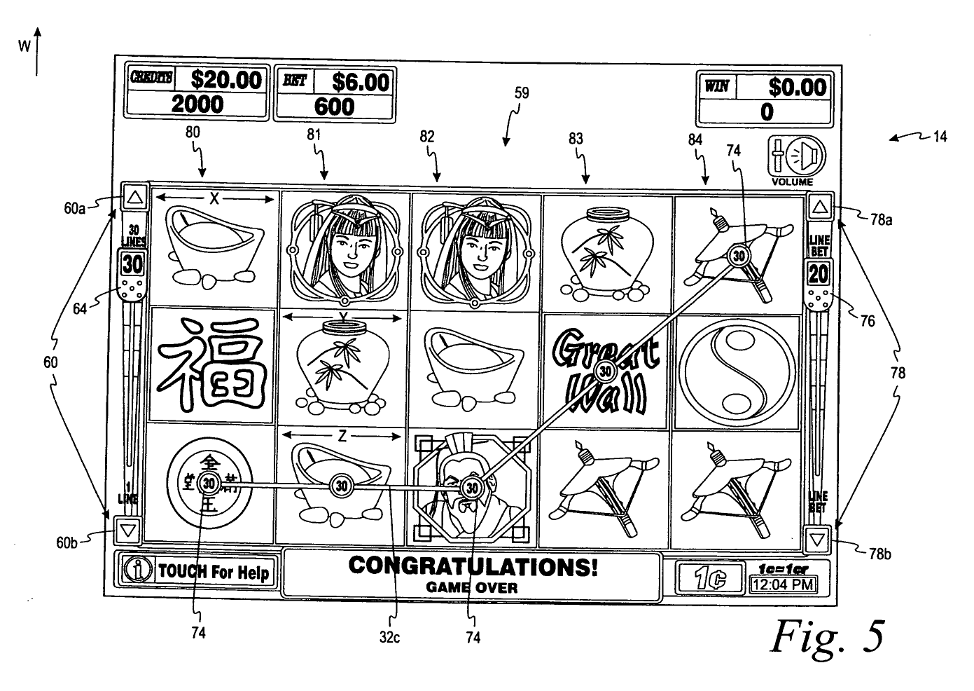

Referring now to FIG. 5, the player has increased the number of paylines, via the payline increaser 60a, from five (shown in FIG. 4) to thirty (the maximum in the illustrated embodiment). Accordingly, the payline indicator 64 numerically indicates that thirty paylines have been selected. Furthermore, the payline indicator 64 has moved a maximum distance in the direction of arrow W to visually indicate the increase in the number of paylines. A thirtieth payline 32c, including tags 74, is displayed on the symbol locations comprising the thirtieth payline—80z, 81z, 82z, 83y, and 84x.

Each payline (e.g., 32a, 32b, 32c) may be displayed in a different color to help visually differentiate the paylines to the player. For example, the first payline 64 may be displayed in red, the fifth payline 32b may be displayed in purple, while the thirtieth payline 32c may be displayed in yellow. Additionally, the non-illustrated paylines (i.e., second thru fourth, sixth thru twenty-ninth) may also be displayed in various colors.

Referring back to FIG. 3, in some embodiments of the present invention, the game screen 59 includes a movable wager per payline indicator 76 as shown in FIGS. 3-5. The number displayed within the wager per payline indicator 76 is the wagered amount that the player has made per payline 32. The wager per payline player-input device 78 is provided to increase and/or decrease the number of wagers per line. Accordingly, a wager per payline increaser 78a increases the wagers per line while a wager per payline decreaser 78b decreases the wagers per line. The wager per payline indicator 76 functions in much the same way as the payline indicator 64 described above. For example, if the player wishes to select additional wagers per payline 32, he or she would use the wager per payline increaser 78a to increase the number of wagers per payline

As noted with respect to FIG. 5, the payline indicator 64 is set to its maximum number of paylines. Likewise, the wager per payline indicator 76 is also set to its maximum number of wagers per line—twenty in this embodiment. Thus, the player is wagering 600 credits in this game. As shown, the game is a penny-denomination game such that the total bet is $6.00. When the payline indicator 64 and/or the wager per payline indicator 76 are in their respective maximum positions, the payline indicator 64 and/or the wager per payline indicator 76 may be visually altered to indicate their respective maximum state. For example, the area generally proximate to each indicator 64, 76 may be highlighted with a bright colored border. Additionally or alternatively, a sound may be provided after the payline indicator 64 and/or the wager per payline indicator 76 reach their respective maximum states. The visual alteration and/or sound helps promote to the player that one or both of the indicators (64, 76) are in the maximum state. In an alternative embodiment, the tags 74 on each of the symbols may display the bet per line (e.g., 20 credits) rather than, or in addition to, the number of the payline displayed (e.g., 30) in FIG. 5.

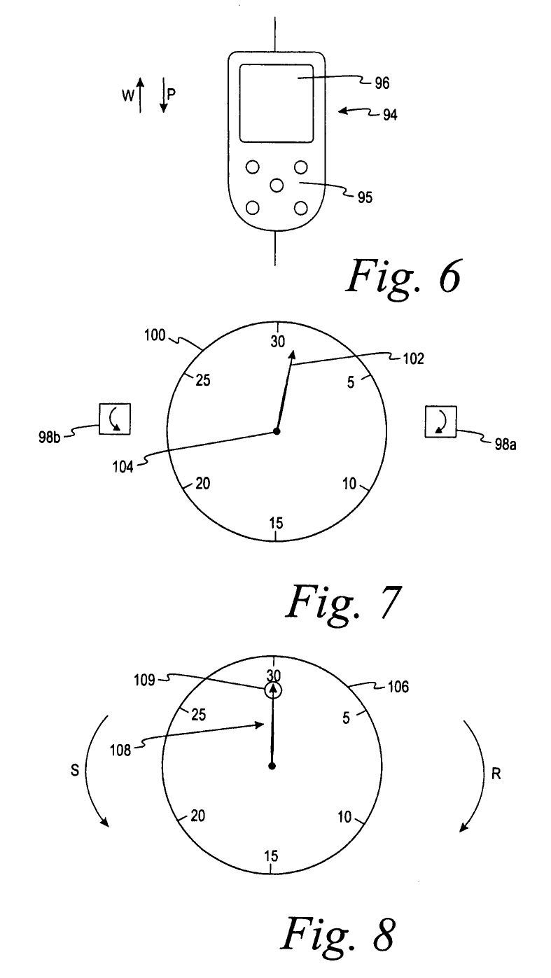

The payline player-input device 60, the payline indicator 64, the wager per payline player-input device 78, and the wager per payline indicator 76 may take various forms in addition to those disclosed thus far. For example, in one embodiment the payline player-input device 60 and the payline indicator 64 can be embodied in the same component. Such an embodiment is shown in FIG. 6 as a payline player-input and indicator device 94. The payline player-input and indicator device 94 may include a player-contact area 95 and a payline display area 96. The player-input and indicator device 94 may be a touch screen input and video display device in combination, or may alternatively be an electromechanical input device (such as a slider, dial, button, etc.) with an accompanying visual display affixed thereto.

To increase the number of paylines, a player first makes contact with the payline player-input and indicator device 94, preferably at the player-contact area 95. Maintaining contact with the player-contact area 95, the player will move the payline player-input and indicator device 94 in the direction of arrow W. The number of paylines selected is shown in the payline display area 96. As the payline player-input and indicator device 94 is moved in the direction of arrow W, the number of paylines 32 increases and the increase is displayed on the payline display area 96. To decrease the number of paylines 32 in this embodiment, the player makes contact with the payline player-input and indicator device 94 and moves it in the direction of arrow P. As the payline player-input and indicator device 94 is moved in the direction of arrow P, the number of paylines decrease as optionally indicated on the payline display area 96. The directions indicated by arrows W and P should not limit the directions in which the payline player-input and indicator device 94 may be moved to increase and/or decrease the number of paylines. The payline player-input and indicator device 94 may be moved in any of a plurality of directions to increase and/or decrease the number of paylines in other embodiments.

Referring now to FIG. 7, another embodiment of the present invention is illustrated. A payline indicator device 100 includes a movable indicator 102 pivotable around a hinge point 104. The payline indicator device 100 also includes numbers along its periphery representing a selectable number of paylines. The movable indicator 102 may take the form of an arrow, indicating via “pointing,” the selected number of paylines. To pivot the indicator 102, thereby increasing and/or decreasing the number of paylines selected, a player may use payline player-input device 98.

The payline player-input device 98 includes a payline increaser 98a and a payline decreaser 98b. To use the payline increaser 98a and/or the payline decreaser 98b, the player contacts the respective device (98a and/or 98b) or causes the same to be contacted. For example, to increase the number of paylines from 1 (as illustrated in FIG. 7) to 15 (not illustrated), the player contacts the payline increaser 98a causing the indicator 102 to pivot around the hinge point 104 until the end opposite the hinge point 104 points toward the number 15 on the periphery of the payline indicator device 100.

The payline indicator device 100 and the payline player-input device 98 may also be embodied in the same component as illustrated in FIG. 8—payline player-input and indicator device 106. The payline player-input and indicator device 106 includes an indicator 108 having a tip 109. The payline player-input and indicator device 106 also includes numbers on its periphery representing selectable numbers of paylines. The number of paylines selected is displayed to the player via the tip 109, which points to the number of selectable paylines surrounding the indicator 108. To increase the number of paylines, the player first makes contact with the indicator 108 of the payline player-input and indicator device 106. Maintaining contact, the player moves the tip 109 of the indicator 108 in the direction of arrow R. To decrease the number of paylines, the player makes contact with the indicator 108 and moves the tip 109 of the indicator 108 in the direction of arrow S.

While the above-described embodiments of FIGS. 6-8 have been provided in relation to payline devices (e.g., payline player-input device 60 and payline indicator 64), the examples provided are applicable to the wager per payline devices in much the same way as described in relation to the payline devices. The various alternatives should not be limited solely to the payline devices. Regardless of the specific form of the devices, the principles of use and function described herein shall remain the same.

Furthermore, in some embodiments, the paylines 32 and the wager per paylines are only selectable via the player input device 24. In those embodiments, the above-described tags (e.g., 63, 70, 74) may still be utilized to show either the number of paylines wagered or the wager per payline.

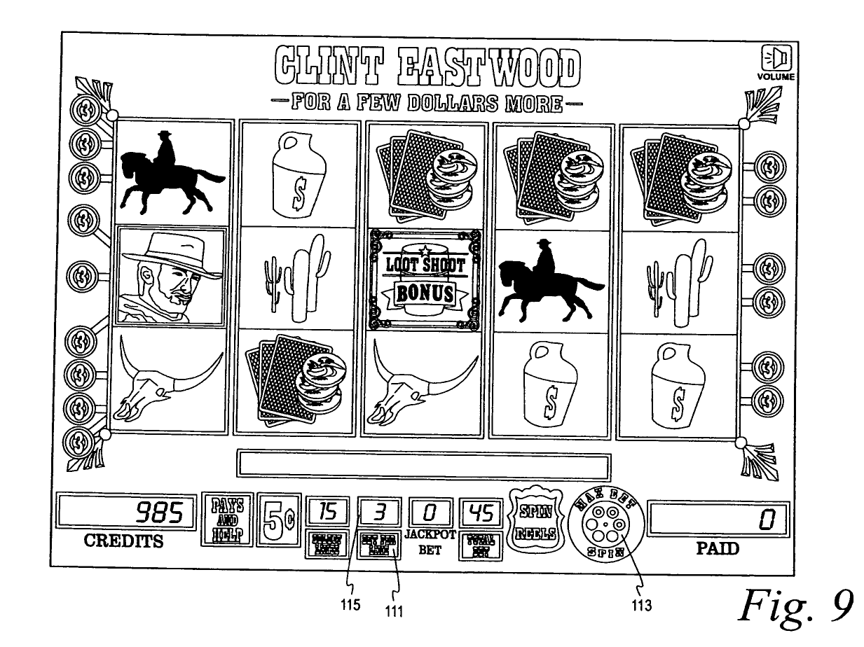

The present invention may also be incorporated in various themed games. For example, a “wild west”-themed game is illustrated in FIG. 9. In this game, a wager per payline indicator 113 may take the form of a bullet chamber as used in a revolver gun. The wager per payline indicator 113, as illustrated in FIG. 9, shows three bullets in the chamber. The bullets represent the selected number of wagers per payline. The number of wagers per payline is also indicated in a secondary wager per payline indicator 115. To increase and/or decrease the number of wagers per payline, the player uses a wager per payline player-input device 111. Additionally, the player may increase and/or decrease the number of wagers per payline contacting the wager per payline indicator 113 with his/her finger and rotating same clock-wise or counter clock-wise. Upon increasing and/or decreasing the number of wagers per line via the wager per payline player-input device 111, the wager per payline indicator 113 may spin, similar to a bullet chamber of a revolver gun, prior to displaying the number of wagers per line selected. This themed-embodiment may also be applied to a payline indicator. It should be noted that the indicators along the sides of the screen display a “3.” This is because three wagers per payline have been selected. Accordingly, the indicators change numbers according to the player selections.

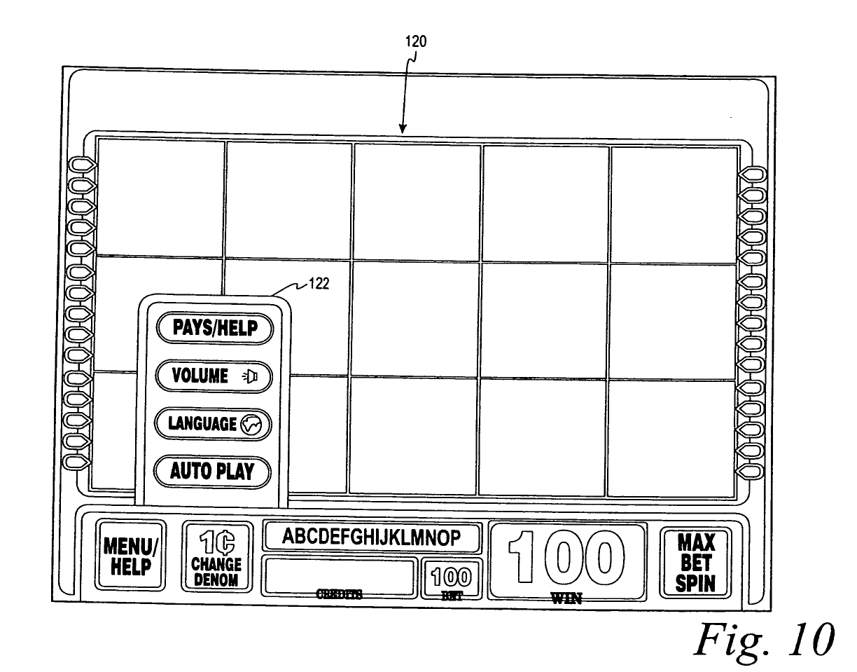

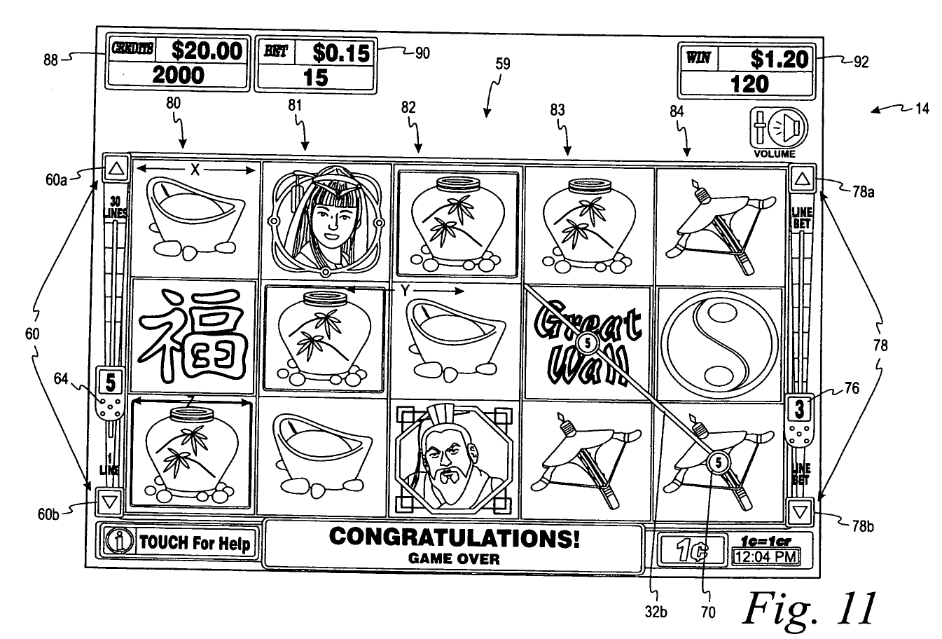

Referring now to FIG. 10, a game screen 120 may include a slide-out window 122 under certain conditions. When a player contacts certain buttons on the game screen 120 (e.g., “Menu/Help” button), the slide-out window 122 appears, similar to a sliding cash register drawer, to display more options relating to the originally contacted button. The slide-out window 122 is not visible on the game screen 120 until a button is contacted, prompting the slide-out window 122 to appear. The slide-out window 122 may be used for standard menu operations (as illustrated) or also for payline number and wager per payline functions. The slide-out window 122 may be located anywhere on the game screen (e.g., top, bottom, left, right).

The embodiments described thus far generally relate to improvements in the display 14 and/or game screen occurring before a spin is generated to help the player more easily select the number of lines he or she wants to play and the wager per payline he or she wants to make. The following embodiments and examples relate to improvements in the display 14 and/or game screen occurring after a spin is complete.

Referring to FIG. 11, the reels 80-84 are shown after they have stopped spinning. The fifth payline 32b (see FIG. 4) is a winning payline with the symbols in locations 80z, 81y, and 82x being the winning symbols. Accordingly, the symbols in locations 83y and 84z are non-winning symbols. To indicate to the player which particular payline is a winning payline, tags 70 including the payline number, may be displayed over the non-winning symbol locations as illustrated, while the winning symbols are highlighted by a box around each winning symbol in the combination. Accordingly, in this embodiment, the winning fifth payline 32b includes tags 70 displayed over the non-winning symbol locations 83y and 84z. The tags 70 indicate, via the number “5”, that the fifth payline 32b is a winning payline. The winning symbols in this embodiment (80z, 81y, 82x) may be highlighted with a border of the same color as the fifth payline 32b and the tags 70.

It should be noted that the game screen 59 may also include, among other features, a credit meter 88, a wager indicator 90, and a win indicator 92, each containing text therein. The credit meter 88 shows the value and amount of credits available to the player. The wager indicator 90 shows the total value and number of credits being wagered by the player, i.e., the number of lines multiplied by the wagers per line. The win indicator 92 indicates in a clear and simple manner the value and number of credits won to the player. In some embodiments, the text on certain displays (e.g., the win indicator 92) matches the color of the winning payline (i.e., border of winning symbols, fifth payline 32b, and tags 70) so that the player can relate the win to a particular payline win.

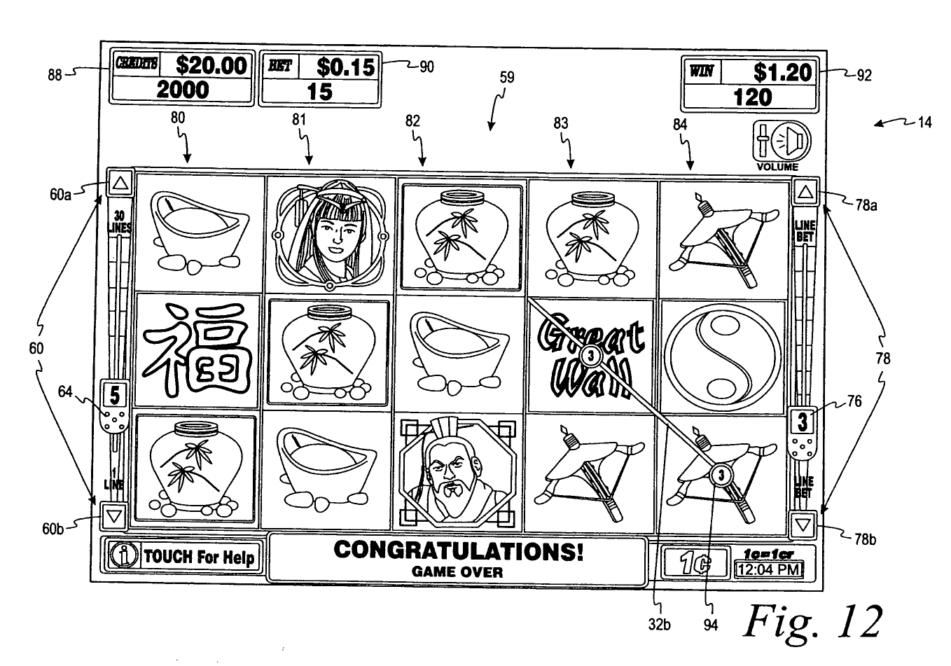

As illustrated in FIG. 12, tags 94 displayed on the non-winning symbols of a winning payline may additionally or alternatively include the wager per payline number to illustrate which particular payline is a winning payline and the wager made per that payline. Again, the winning payline and corresponding tags 94 may be the same color as the text on certain displays (e.g., the win indicator 92) so that the player can relate the win to a particular payline win.

In the foregoing Detailed Description, it can be seen that various features may be grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. The scope of the invention is defined by the following claims and the equivalents thereof.

What is claimed is:

1. A gaming machine for conducting a wagering game, comprising:
a display for displaying a plurality of symbols on a plurality of reels defining an array, said array including a plurality of player-selectable paylines indicating symbol combinations in said array;
a player-input device receiving input from a player for selecting one or more of said player-selectable paylines;
a payline indicator movable along a vertical path in a direction alongside said plurality of reels, said payline indicator indicating a number corresponding to selected ones of said player-selectable paylines; and
a controller in communication with said display and programmed to activate said selected ones of said player-selectable paylines during said wagering game.

2. The gaming machine of claim 1, wherein said payline indicator is movable between a minimum number of paylines and a maximum number of paylines.

3. The gaming machine of claim 2, wherein said display is adapted to display each player-selectable payline as said payline indicator is moved between said minimum number of paylines and said maximum number of paylines.

4. The gaming machine of claim 1, wherein said player-input device and said payline indicator are included on the same component.

5. The gaming machine of claim 1, wherein said player-input device is adapted to receive input regarding the paylines in a sequential manner.

6. The gaming machine of claim 1, further comprising a wager-input device for receiving a wager for each of said selected ones of said player-selectable paylines.

7. The gaming machine of claim 6, further comprising a wager indicator movable along a path for indicating said wager per payline of said selected ones of said player-selectable paylines.

8. The gaming machine of claim 7, wherein said path for said wagering indicator is a vertical path.

9. The gaming machine of claim 1, wherein said player-input device includes a rotatable dial.

10. The gaming machine of claim 1, wherein said player-input device includes a movable slider bar.

11. The gaming machine of claim 1, wherein said payline indicator includes a dial, said path being located on said dial.

12. The gaming machine of claim 1, wherein said payline indicator includes a screen for numerically indicating the number of paylines.

13. The gaming machine of claim 1, further comprising a speaker for emitting a sound when a predetermined number of said paylines is selected.

14. The gaming machine of claim 1, further comprising a player-prompted slide-out window that is displayed on said display, said slide-out window providing a wager input device for receiving a wager for each of said selected ones of said player-selected paylines.

15. A method of conducting a wagering game, comprising the acts of:
displaying a plurality of symbols arranged in an array, said array including a plurality of player-selectable paylines indicating symbol combinations in said array;
selecting, via a player-input device, one or more of said player-selectable paylines, said player-selectable paylines ranging between a minimum number of paylines and a maximum number of paylines;
in response to said selecting, moving a payline indicator along a vertical path alongside said array for indicating a number corresponding to selected ones of said player-selectable paylines; and
activating said selected ones of said player-selectable paylines during said wagering game.

16. The method of claim 15, further comprising the act of selecting, via a wager-input device, a wager for said selected ones of said player-selectable paylines, said wager having a range between a minimum number and a maximum number.

17. The method of claim 16, wherein at least one of said selected ones of said player-selectable paylines is a winning payline.

18. The method of claim 17, further comprising indicating said winning payline via tags located on said winning payline.

19. The method of claim 18, wherein said tags indicate said wager that is associated with said winning payline.

20. The method of claim 18, further comprising displaying an award-indication region on a display to indicate a total monetary award associated with said winning payline, said award-indication region including indicia corresponding to indicia on said tags.

21. The method of claim 15, wherein said selecting of selected ones of said plurality of paylines includes moving, via player input, said player-input device between a first location and a second location.

22. The method of claim 15, wherein said selecting includes prompting a player through a slide-out window to provide an input related to said player-selectable paylines.

23. A gaming machine for conducting a wagering game, comprising:
a display for displaying a plurality of symbols arranged in an array, said array including a plurality of player-selectable paylines extending across symbol locations in said array;
a payline input device receiving input from a player for selecting one or more of said player-selectable paylines;
a wager input device receiving input from a player for a wager for each of said selected player-selectable paylines;
a wager per payline indicator movable along a vertical path for indicating wagers corresponding to selected ones of said player-selectable paylines; and
a controller in communication with said display and programmed to activate said selected ones of said player-selectable paylines during said wagering game.

24. A gaming machine for conducting a wagering game, comprising:
a display for displaying a plurality of symbols arranged in an array, said array including a plurality of player-selectable paylines extending across symbol locations in said array;
a payline input device receiving input from a player for selecting one or more of said player-selectable paylines;
a plurality of tags displayed on the display along the selected ones of the player-selectable paylines, the plurality of tags visually indicating to the player at least one of the identification of the selected ones of the player-selectable paylines and the wager for the selected ones of the player-selectable paylines; and
a controller in communication with said display and programmed to activate said selected ones of said player-selectable paylines during said wagering game.
